(19) United States
(12) Patent Application Publication
(10) Pub. No.: US 2006/0198095 A1
(43) Pub. Date: Sep. 7, 2006

(54) Self-lock assembly of a disk drive and a chassis

(75) Inventor: Cheng-Fu Lee, Hsinchu City (TW)

Correspondence Address: LOWE HAUPTMAN BERNER, LLP, 1700 DIAGONAL ROAD, SUITE 300, ALEXANDRIA, VA, 22314, US

(73) Assignee: LITE-ON IT Corp.

(21) Appl. No.: 11/070,092

(22) Filed: Mar. 3, 2005

(51) Int. Cl. G06F 1/16

(52) U.S. Cl. 361/685

(57) ABSTRACT

A disk drive to be mounted on a chassis has lateral sides further including lower edges. The lower edges provide a plurality of restraint flanges, a plurality of position stems, and a plurality of constraint parts. The chassis has a plurality of hooks, a plurality of guiding holes, a plurality of deflection arms. While in a lock-on state of the disk drive and the chassis after performing a slide-and-lock operation in between, the restraint flanges are nested inside the respective hooks, the position stems are located at respective anchoring ends of the respective guiding holes, and the constraint parts form interference relationship with the respective deflection arms.

### BACKGROUND OF THE INVENTION

(1) Field of the Invention

The invention relates to a self-lock assembly of a disk drive and a chassis, and more particularly to the assembly that utilizes several non-screw position pairs between the disk drive and the chassis to facilitate the mounting in between.

(2) Description of the Prior Art

Recently, optical disks as efficient communicative storage means have been widely applied to be feasible to most electronic devices such as office facilities, computers, entertainment equipments, industrial control boxes and so on. For reading and/or writing the optical disks, a disk drive as a player and/or a recorder is common for the domestic device to manage the message stored or to be stored in the optical disk.

In the art, for the disk drive to be mounted into/onto the device, a chassis inside the device is usually used as a solid platform for anchoring the disk drive. Referred to FIG.1, an exploded view showing a typical mounting between a disk drive 2, or say a loader, and a chassis 1 is illustrated. As shown, the disk drive 2 has a pair of ears 21 located at a respective lower edge 201 of each lateral side 20 (shown only, one side in the figure). Each ear 21 has a central hole 211 for a screw 3 to penetrate through. On the chassis 1, four screw holes 11 respective in position to the central holes 211 of the ears 21 are included. While in mounting, each screw 3 is sent through the respective central hole 211 and the respective screw hole 11 to engage firmly with a washer 4 and a nut 5 at a bottom of the chassis 1.

Apparently, in the conventional mounting as described above, plenty of tiny pieces including the screws 3, the washers 4 and the nuts 5 are involved. It is easy to conclude that the task for an operator in an assembly line to handle those tiny pieces would be notorious and easy to fatigue the operator. Also interestingly to note, even though the mounting of the disk drive 2 onto the chassis 1 seems to be simple, yet labor time for completing such a mounting is usually much more than expected. As a consequence, the yield or efficiency of the mounting is remarkably low by compared to other assembly work of the device to equip the disk drive 2.

Therefore, any improvement upon the aforesaid mounting between the disk drive 2 and the chassis 1 will help the yield of manufacturing the device having the disk drive 2 and be definitely appreciated by the skilled in the art.

### SUMMARY OF THE INVENTION

Accordingly, it is an object of the present invention to provide a self-lock assembly of a disk drive and a chassis which can waive all the tiny pieces mentioned above by introducing a slide-to-lock operation for easing the assembling and thus can save the labor time for the mounting.

In accordance with the present invention, the disk drive of the assembly has lateral sides, and each of the lateral sides further has a lower edge for sitting on the chassis. The lower edge of the lateral side includes at least a restraint flange, at least a position stem, and at least a constraint part. The chassis for mounting the disk drive includes at least a hook located at a position for receiving the restraint flange during the mounting, at least a guiding hole located at a position for receiving the position stem during the mounting, and at least a deflection arm located at a position for receiving the constraint part during the mounting.

In the present invention, the disk drive is mounted onto the chassis according to a slide-and-lock operation. Through the slide-and-lock operation, the restraint flange can be nested inside the respective hook, the position stem can be positioned at the respective guiding hole, and the constraint part can form an interference relationship with the respective deflection arm.

In one embodiment of the present invention, the restraint flange can further include a reinforced flange for forming another interference relationship with the respective hook as the slide-and-lock operation is completed.

In one embodiment of the present invention, the guiding hole can further have an anchoring end and a leading end opposing to the anchoring end. During the slide-and-lock operation, the position stem can slide from the leading end to the anchoring end. Preferably, the anchoring end provides an accommodation space for substantially fitting the position stem, and the leading end provides another accommodation space larger than the anchoring end does.

In one embodiment of the present invention, the deflection arm can further include a leading slope for the constraint part to slide over easily during the slide-and-lock operation.

In one embodiment of the present invention, the constraint part can further have a riding slope for sliding smoothly over the deflection arm during the slide-and-lock operation.

In one embodiment of the present invention, the lateral side can further include a slot cut to make the constraint part shaped as a cantilever beam.

All these objects are achieved by the assembly of the disk drive and the chassis described below.

### BRIEF DESCRIPTION OF THE DRAWINGS

The present invention will now be specified with reference to its preferred embodiment illustrated in the drawings, in which:

FIG. 1 is an exploded view of a conventional assembly of a disk drive and a chassis;

FIG. 2 is an exploded view of a preferred assembly of a disk drive and a chassis in accordance with the present invention;

FIG. 3 is a perspective view of FIG. 2;

FIG. 4 is a cross-sectional side view of FIG. 3 along line a-a of FIG. 3;

FIG. 5A is a schematic view showing a pre-lock state of the preferred position pair in accordance with the present invention;

FIG. 5B is a schematic view showing a lock-on state of FIG. 5A;

FIG. 6 is an enlarged side view of the preferred snap pair of FIG. 4; and

FIG. 7 is an enlarged side view of another embodiment of the snap pair in accordance with the present invention.

### DESCRIPTION OF THE PREFERRED EMBODIMENTS

The invention disclosed herein is directed to an assembly of a disk drive and a chassis. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

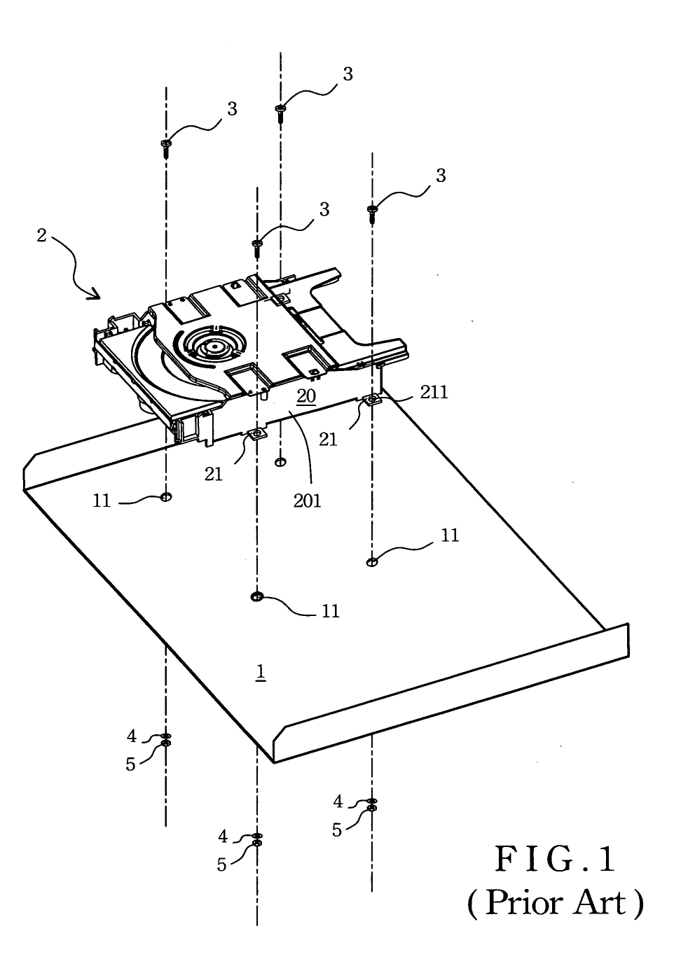

In the present invention, the assembly of the disk drive and the chassis is designed to introduce an easy-operated slide-and-lock operation, which will be detailed below and will demonstrate a superior assembly performance than the conventional design as shown in FIG. 1.

The disk drive of the present invention is to be mounted on a chassis and has lateral sides. Each of the lateral side concerned further includes a lower edge to sit on the chassis in the assembly. The lower edge can provide a plurality of restraint flanges, a plurality of position stems, and a plurality of constraint parts to mate with respective parts constructed on the chassis, preferably constructed by punching or stamping. Those respective parts on the chassis are a plurality of hooks, a plurality of guiding holes, a plurality of deflection arms. After the disk drive performs the slide-and-lock operation with respect to the chassis, a lock-on state in between is achieved by having the restraint flanges nest inside the respective hooks, the position stems position at respective anchoring ends of the respective guiding holes, and the constraint parts form interference relationship with the respective deflection arms.

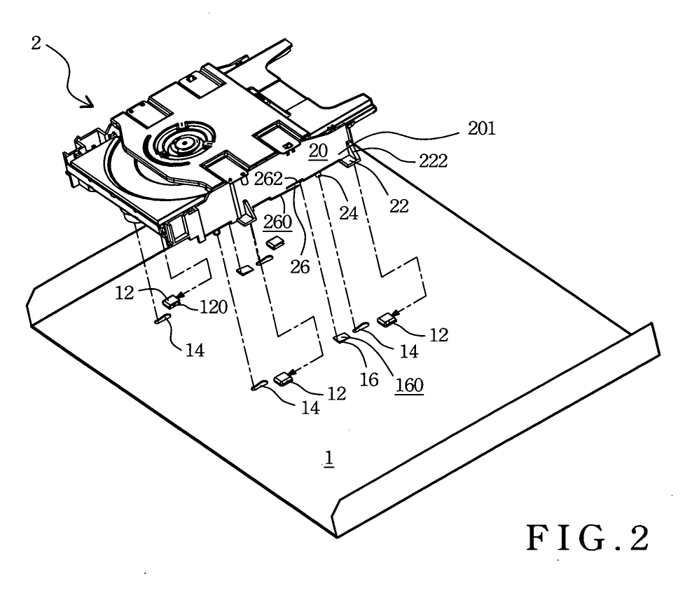

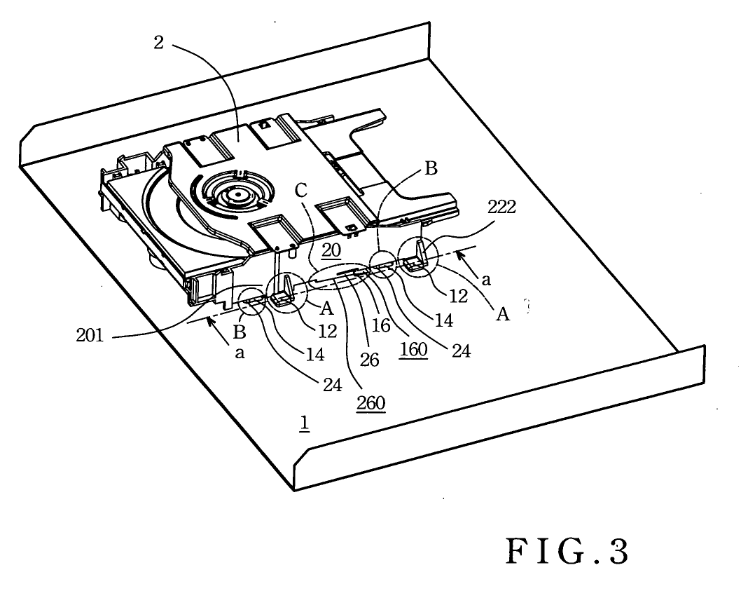

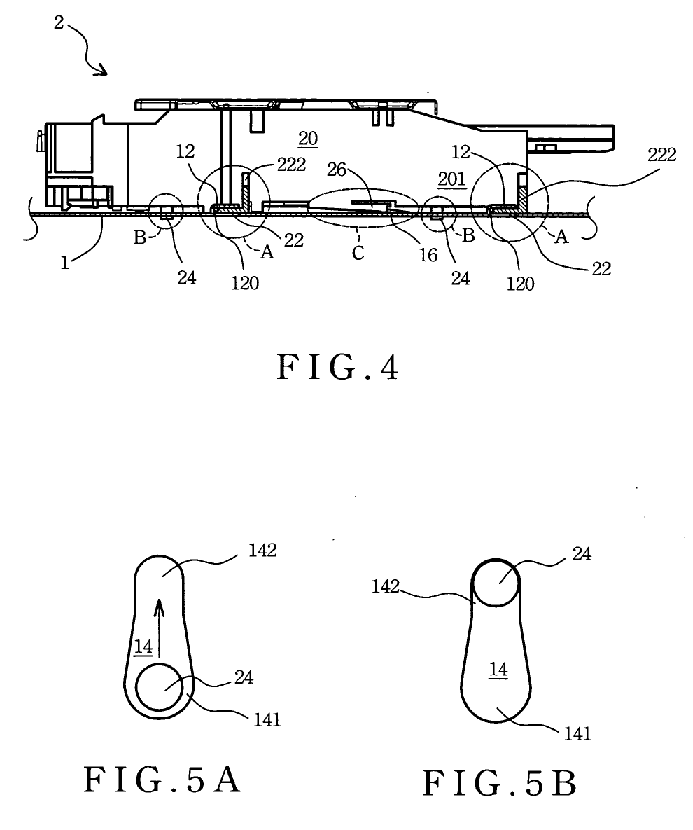

Referring now to FIG. 2, FIG. 3 and FIG. 4, a preferred embodiment of the present invention is shown by an exploded view, an assembled perspective view and a side view along a cross-sectional line, respectively.

The disk drive 2 to be mounted on the chassis 1 has two opposing lateral sides 20. Each the lateral side 20 further includes a lower edge 201 lying along lower portion of the lateral side 20. Each of the lower edges 201 can provides a plurality of restraint flanges 22 (two in the figures), a plurality of position stems 24 (two in the figures), and a constraint part 26 (one in the figures but two totally on the disk drive 2).

The chassis 1 has a plurality of hooks 12 (four in the figures), a plurality of guiding holes 14 (four in the figures), a deflection arm 16 (two in the figures).

Basically, three formations have been constructed to erect the self-locking ideology of the present invention. That is a fastening pair A, a position pair B and a snap pair C. Each fastening pair A includes the restraint flange 22 of the disk drive 2 and the respective hook 12 of the chassis 1. Each position pair B includes position stem 24 of the disk drive 2 and the respective guiding hole 14 of the chassis 1. Each snap pair C includes the constraint part 26 of the disk drive 2 and the respective deflection arm 16 of the chassis 1.

Definition 1: A “Pre-lock state” is a state between the disk drive 2 and the chassis 1 that the restraint flange 22 is separated from the respective hook 12 in the fastening pair A, the position stem 24 is not located at a anchoring end 142 of the respective guiding hole 14 in the position pair B, and a constraint end 261 of the constraint part 26 does not form a head-to-head contact with a deflection end 161 of the deflection arm 16 in the snap pair C.

Definition 2: A “Lock-on state” is a state between the disk drive 2 and the chassis 1 that the restraint flange 22 is nested in a nest cavity 120 of the respective hook 12 in the fastening pair A, the position stem 24 is located at the anchoring end 142 of the respective guiding hole 14 in the position pair B, and the constraint end 261 of the constraint part 26 forms a head-to-head contact with the deflection end 161 of the deflection arm 16 in the snap pair C.

Definition 3: A “Slide-and-lock operation” is an operation to mount the disk drive 2 onto the chassis 1 that changes the relationship of the disk drive 2 and the chassis 1 from a pre-lock state to a lock-on state.

Clearly, FIG. 2 can be used to elucidate the pre-lock state, while FIG. 3 can be used to demonstrate the lock-on state. Also, the slide-and-lock operation can be realized by dashed lines of FIG. 2; particularly, by the dashed lines leading the restraint flanges 22 to the respective hook 12.

In the present invention, a complete assembly of the disk drive 2 and the chassis 1 is a state of the lock-on state; i.e. the state of the restraint flanges 22 nesting inside the respective hooks 12, the position stems 24 locating at respective anchoring ends 142 of the respective guiding holes 14, and the constraint parts 26 forming an interference relationship (or say, the head-to-head contact as described in Definition 2) with the respective deflection arms 16.

As shown in this preferred embodiment of the present invention, the restraint flange 22 can further include a reinforced flange 222 for reinforcing the construction of the restraint flange 22 and also forming another interference relationship with the respective hook 22 as the slide-and-lock operation is completed. That is that the reinforced flange 222 can play as a stop for the slide-and-lock operation while hitting the hook 22 during the mounting of the disk drive 2 onto the chassis 1. In particular, the reinforced flange 222 can be shaped as a triangle rib to connect the lateral side 20 of the disk drive 2 with the restraint flange 22.

Particularly, at a minimal design level of the present invention, the assembly of the disk drive 2 and the chassis 1 needs only the fastening pairs A, preferably two at each lateral side 20. Definitely, the aforesaid position pair B and snap pair C can be arbitrarily added in.

Referring now to FIG. 5A and FIG. 5B, schematic views for demonstrating a pre-lock state and the lock-on state of the preferred position pair B in accordance with the present invention are shown, respectively. In this embodiment, the guiding hole 14 can further have an anchoring end 142 and a leading end 141 opposing to the anchoring end 142. During the slide-and-lock operation, the position stem 24 can firstly be sent into the leading end 141 and then slide from the leading end 141 to the anchoring end 142. Preferably, the anchoring end 142 provides an accommodation space for substantially fitting the position stem 24 so that an accurate positioning can be achieved, and the leading end 141 provides another accommodation space larger than the anchoring end 142 does so that the guiding hole 14 can easily receive the position stem 24 and can also smoothly guide the position stem 240 to the anchoring end 142.

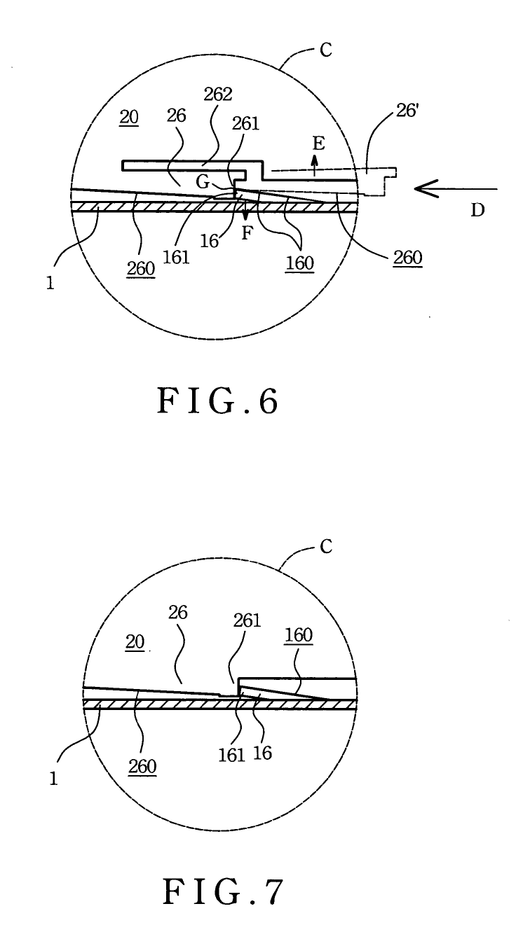

Referring now to FIG. 6, a schematic enlarged view of the snap pair C of FIG. 3 is shown. In this embodiment, the deflection arm 16 can further include a leading slope 160 for the constraint part 26 to slide over easily during the slide-and-lock operation. Also, the constraint part 26 can further have a riding slope 260 for sliding smoothly further over the deflection arm 16 during the slide-and-lock operation. In addition, the lateral side 20 can further include a slot cut 262 to make the constraint part 26 shaped as a cantilever beam so that better elasticity of the constraint part 26 can be obtained.

As shown in FIG. 6, the local slide-and-lock operation is elucidated by the dash-lined constraint part 26′ approaching the solid-lined constraint part 26 along a direction D. During the approaching, the constraint part 26 can be pushed and deflected upward (denoted by arrow E) to ride over the deflection arm 16, while the deflection arm 16 is depressed downward (denoted by arrow F). As long as the deflection arm 16 passes the bottom surface 260 of the constraint part 26, the normal forcing between the deflection arm 16 and the constraint part 26 can be suddenly released and have the deflection arm 16 and the constraint part 26 jump to a point G as shown. At the point G, the constraint end 261 of the constraint part 26 forms the head-to-head contact with the deflection end 161 of the deflection arm 16 and thereby the assembly of the disk drive 2 and the chassis 1 is locked. Also, while the depressing in between is suddenly released, a “click” sound will be generated by dynamic jump motions of the constraint part 26 and the deflection arm 16.

Referring now to FIG. 7, another embodiment of the snap pair C is shown. Compared with the previous embodiment of FIG. 6, this embodiment waive the design of the slot cut 262. However, even under such an change upon this embodiment, the operation of the snap pair C as described above can be still sustained except for the elasticity of the constraint part 26.

By providing the fastening pair, the position pair and the snap pair to the present invention, a easy-operated self-lock assembly of the disk drive and the chassis can be obtained and thus labor for performing the assembling can be greatly saved.

While the present invention has been particularly shown and described with reference to a preferred embodiment, it will be understood by those skilled in the art that various changes in form and detail may be without departing from the spirit and scope of the present invention.

I claim:

1. An assembly of a disk drive and a chassis, comprising:
a plurality of restraint flanges, located at lower edges of lateral sides of the disk drive;
a plurality of hooks, located at the chassis at positions respective to the restraint flanges, each of the hooks further having thereinside a nest cavity for receiving the respective restraint flange;
a plurality of position stems, located at the lower edges of the lateral sides of the disk drive;
a plurality of guiding holes, located at the chassis at positions respective to the position stems, each of the guiding holes further having an anchoring end for positioning the respective position stem;
a plurality of constraint parts, located at the lower edges of the lateral sides of the disk drive; and
a plurality of deflection arms, located at the chassis at positions respective to the constraint parts;
wherein the disk drive is mounted onto the chassis according to a slide-and-lock operation; wherein, after completing the slide-and-lock operation, the restraint flanges are nested inside the respective hooks, the position stems are located at the respective anchoring ends of the respective guiding holes, and the constraint parts form an interference relationship with the respective deflection arms.

2. The assembly of a disk drive and a chassis according to claim 1, wherein said restraint flange further includes a reinforced flange for forming another interference relationship with said respective hook as said slide-and-lock operation is completed.

3. The assembly of a disk drive and a chassis according to claim 1, wherein said guiding hole further has a leading end opposing to said anchoring for receiving said position stem prior to said slide-and-lock operation, and wherein said position stem slides from the leading end to said anchoring end during said slide-and-lock operation.

4. The assembly of a disk drive and a chassis according to claim 3, wherein said anchoring end provides an accommodation space for substantially fitting said position stem and said leading end provides another accommodation space larger than said anchoring end does.

5. The assembly of a disk drive and a chassis according to claim 1, wherein said deflection arm further includes a leading slope for said constraint part easing to slide over during said slide-and-lock operation.

6. The assembly of a disk drive and a chassis according to claim 1, wherein said constraint part further has a riding slope for sliding smoothly over said deflection arm during said slide-and-lock operation.

7. The assembly of a disk drive and a chassis according to claim 1, wherein said lateral side further includes a slot cut to make said constraint part as a cantilever beam.

8. A combination of a disk drive and a chassis, the disk drive comprising at least a lateral side further having a lower edge, the lower edge further comprising:
at least a restraint flange;
at least a position stem; and
at least a constraint part; and
the chassis further comprising:
at least a hook, located at a position for receiving the restraint flange while the disk drive is mounted onto the chassis;
at least a guiding hole, located at a position for receiving the position stem while the disk drive is mounted onto the chassis; and
at least a deflection arm, located at a position for receiving the constraint part while the disk drive is mounted onto the chassis.
wherein, while the disk drive is mounted onto the chassis according to a slide-and-lock operation, the constraint part forms an interference relationship with the respective deflection arm.

9. The combination of a disk drive and a chassis according to claim 8, wherein said restraint flange further includes a reinforced flange for forming another interference relationship with said respective hook as said slide-and-lock operation is completed.

10. The combination of a disk drive and a chassis according to claim 8, wherein said guiding hole further has an anchoring end and a leading end opposing to the anchoring end, and wherein said position stem slide from the leading end to the anchoring end during said slide-and-lock operation.

11. The combination of a disk drive and a chassis according to claim 10, wherein said anchoring end provides an accommodation space for substantially fitting said position stem and said leading end provides another accommodation space larger than said anchoring end does.

12. The combination of a disk drive and a chassis according to claim 8, wherein said deflection arm further includes a leading slope for said constraint part easing to slide over during said slide-and-lock operation.

13. The combination of a disk drive and a chassis according to claim 8, wherein said constraint part further has a riding slope for sliding smoothly over said deflection arm during said slide-and-lock operation.

14. The combination of a disk drive and a chassis according to claim 8, wherein said lateral side further includes a slot cut to make said constraint part as a cantilever beam.

15. A combination of a disk drive and a chassis, the disk drive including two lateral sides, each of the lateral sides further having a lower edge, the assembly comprising:
four restraint flanges, located at lower edges of lateral sides of the disk drive by two at each of the lower edges;
four hooks, located at the chassis at positions respective to the restraint flanges, each of the hooks further having thereinside a nest cavity for receiving the respective restraint flange;
wherein, while the disk drive is mounted onto the chassis according to a slide-and-lock operation, each of the restraint flanges nested in the nest cavity of the respective hook.

16. The combination of a disk drive and a chassis according to claim 15, wherein said restraint flange further includes a reinforced flange for forming an interference relationship with said respective hook as said slide-and-lock operation is completed.

17. The combination of a disk drive and a chassis according to claim 15, further including a plurality of position stems located at said lower edges, and a plurality of guiding holes located at said chassis at positions respective to the position stems, each of the guiding holes further having an anchoring end for positioning the respective position stem; wherein, after completing said slide-and-lock operation, the position stems are located at the respective anchoring ends of the respective guiding holes.

18. The combination of a disk drive and a chassis according to claim 17, wherein said guiding hole further has a leading end opposing to said anchoring end, said anchoring end providing an accommodation space for substantially fitting said position stem and said leading end providing another accommodation space larger than said accommodation space of said anchoring end, and wherein said position stem slide from the leading end to said anchoring end during said slide-and-lock operation.

19. The combination of a disk drive and a chassis according to claim 15, further including a plurality of constraint parts located at said lower edges, and a plurality of deflection arms located at said chassis at positions respective to the constraint parts; wherein, after completing said slide-and-lock operation, the constraint parts form an interference relationship with the respective deflection arms.

20. The combination of a disk drive and a chassis according to claim 19, wherein said deflection arm further includes a leading slope for said constraint part easing to slide over during said slide-and-lock operation.
